(19) United States
(12) Patent Application Publication
(10) Pub. No.: US 2015/0032496 A1
(43) Pub. Date: Jan. 29, 2015

(54) SYSTEMS AND METHODS FOR DIVIDING A SPIFF BUDGET

(71) Applicant: salesforce.com, inc., San Francisco, CA (US)

(72) Inventors: Jager McConnell, San Francisco, CA (US); Ciara Peter, San Francisco, CA (US)

(73) Assignee: salesforce.com, inc., San Francisco, CA (US)

(21) Appl. No.: 13/952,843

(22) Filed: Jul. 29, 2013

(51) Int. Cl. G06Q 10/06

(52) U.S. Cl. CPC G06Q 10/06315; G06Q 10/06393
USPC 705/7.25

(57) ABSTRACT

Systems, methods, and computer program products are provided for optimizing compensation allocations, and in particular, spiff allocations. With a limited budget, embodiments calculate optimized allocations or distributions of the budget to maximize employee productivity by analyzing input parameters associated with a productivity period, creating performance models for each employee or group of employees based on the analysis, and generating a budget allocation model so as to increase the sum output of the employee productivity. Approaches are data driven and modifiable to account for new data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### DIVIDING A SPIFF BUDGET

One or more implementations relate generally to dividing a spiff budget to increase labor force productivity.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A traditional method used by enterprises to increase labor force productivity is to additionally incorporate variable compensation into a labor force's guaranteed compensation plans. The variable compensation is customarily contingent on an individual contributor's performance in a directly proportional manner, i.e., higher performance yields higher variable compensation. Assuming at least that the individual contributor desires higher compensation, the individual contributor's knowledge of his or her variable compensation plan incentivizes the individual contributor to increase his or her performance yielding output and/or results that benefit the enterprise.

However, the enterprise has limited resources with which to incentivize its labor force. Accordingly, it is desirable to provide techniques that yield better allocations of limited resources to incentivize a labor force to increase productivity.

### BRIEF SUMMARY

In accordance with embodiments, there are provided systems, methods, and computer program products for dividing one or more spiff budgets to increase productivity from a labor force. A system analyzes inputs and creates performance models based on the analysis. Based on the created performance models, the system then generates a budget allocation model that proposes at least one division of a budget so as to project increased productivity from a labor force.

Inputs can include data corresponding to entities within an enterprise's labor force, for example, salespeople. The data for the salespeople can include historical data (e.g., each salesperson's past performance associated with previously-assigned sales targets and sales bonuses or spiffs, etc.) or current data (e.g., each salesperson's industry, job title, skill set, customer satisfaction score, availability, etc.). Inputs can also include data corresponding to externalities, for example, customers. The data for the customers can include historical data (e.g., each customer's past purchase frequency and purchase amount of services or products, etc.) or current data (e.g., each customer's industry, customer satisfaction score, location, etc.). Inputs can also include pre-analyzed data such as previously-generated descriptive or inferential models that correlate inputs with productivity.

Performance models project anticipated labor results of entities based on the analysis. A performance model can be a linear or nonlinear model, but in any case, correlates at least one input with at least the anticipated productivity of an entity.

Budget allocation models propose a division of the budget between the labor force entities based on the performance models. The budget allocation models build on the performance models to attempt to propose at least one division that increases or optimizes overall productivity from the enterprise's labor force.

Any of the following described embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers may be used to refer to like elements. Although the following figures depict various examples, the one or more implementations are not limited to the examples depicted in the figures.

FIG. 1 is a block diagram of an example of an environment in which an on-demand database service can be used in accordance with some implementations.

FIG. 2 is a block diagram of an exemplary architecture of a system of an embodiment.

FIG. 3 is a block diagram of an exemplary analysis engine and its interaction with an exemplary model generator according to an embodiment.

FIG. 4 is a graphical representation of an exemplary performance model of an embodiment.

FIG. 5 is a graphical representation of an exemplary spiff budget allocation model of an embodiment.

FIG. 6 is a screenshot of an exemplary user interface according to an embodiment.

FIG. 7 is a flow diagram of an exemplary method according to an embodiment.

### DETAILED DESCRIPTION

### General Overview

Systems, methods, and computer program products are provided for dividing one or more budgets to increase productivity from a labor force. Although embodiments are described with reference to a particular problem of dividing a spiff budget between salespeople/salespersons within the labor force to incentivize increased sales, a skilled artisan will recognize that embodiments have wider applicability than the particular problem. Further, the term salesperson and related singular nouns can be used throughout this disclosure to encompass one or more groups of salespeople.

One of many uses cases for described embodiments is a sales manager tasked with incentivizing a sales team on a particular sales campaign. However, the sales manager has limited resources with which to compensate the sales team; in particular, the sales manager has a limited budget. Based on the limited budget, the sales manager wishes to allocate the budget as spiffs so as to maximize the sum total output of the sales team.

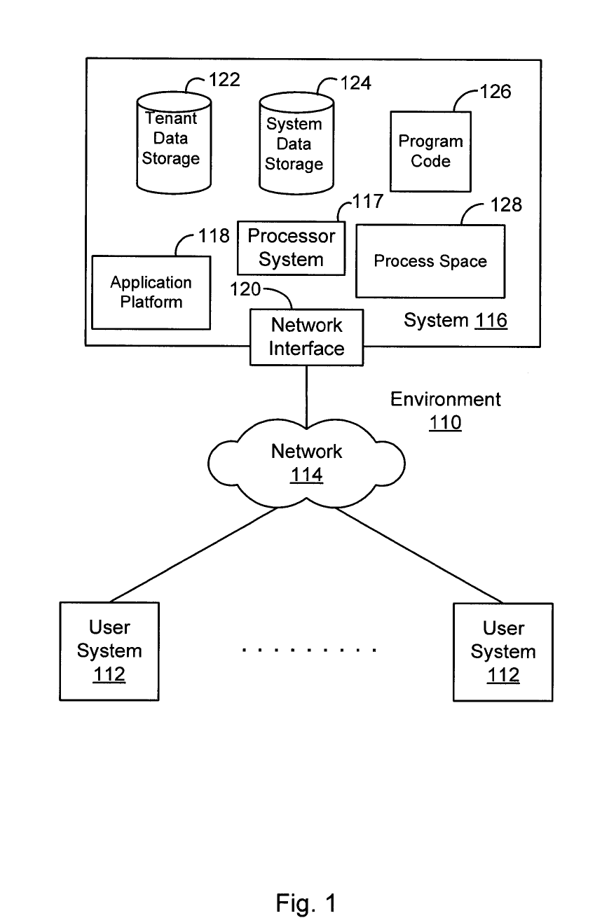

FIG. 1 shows a block diagram of an example of an environment 110 in which an on-demand database service can be used in accordance with some implementations. Environment 110 may include user systems 112, network 114, database system 116, processor system 117, application platform 118, network interface 120, tenant data storage 122, system data storage 124, program code 126, and process space 128. In other implementations, environment 110 may not have all of these components and/or may have other components instead of, or in addition to, those listed above.

Environment 110 is an environment in which an on-demand database service exists. User system 112 may be any machine or system that is used by a user to access a database system 116. For example, any of user systems 112 can be a handheld computing device, a mobile phone, a laptop computer, a work station, and/or a network of such computing devices. As illustrated in FIG. 1 user systems 112 might interact via a network 114 with an on-demand database service, which is implemented in the example of FIG. 1 as database system 116.

An on-demand database service, such as system 116, is a database system that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 118 may be a framework that allows the applications of system 116 to run, such as the hardware and/or software, e.g., the operating system. In some implementations, application platform 118 enables creation, managing and executing one or more applications developed by the provider of the on-demand database service, users accessing the on-demand database service via user systems 112, or third party application developers accessing the on-demand database service via user systems 112.

The users of user systems 112 may differ in their respective capacities, and the capacity of a particular user system 112 might be entirely determined by permissions (permission levels) for the current user. For example, where a salesperson is using a particular user system 112 to interact with system 116, that user system has the capacities allotted to that salesperson. However, while an administrator is using that user system to interact with system 116, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 114 is any network or combination of networks of devices that communicate with one another. For example, network 114 can be any one or any combination of a LAN (local area network), WAN (wide area network), telephone network, wireless network, point-to-point network, star network, token ring network, hub network, or other appropriate configuration. Network 114 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 112 might communicate with system 116 using TCP/IP and, at a higher network level, use other common Internet protocols to communicate, such as HTTP, FTP, AFS, WAP, etc. In an example where HTTP is used, user system 112 might include an HTTP client commonly referred to as a “browser” for sending and receiving HTTP signals to and from an HTTP server at system 116. Such an HTTP server might be implemented as the sole network interface 120 between system 116 and network 114, but other techniques might be used as well or instead. In some implementations, the network interface 120 between system 116 and network 114 includes load sharing functionality, such as round-robin HTTP request distributors to balance loads and distribute incoming HTTP requests evenly over a plurality of servers. At least for users accessing system 116, each of the plurality of servers has access to the MTS' data; however, other alternative configurations may be used instead.

In one implementation, system 116, shown in FIG. 1, implements a web-based customer relationship management (CRM) system. For example, in one implementation, system 116 includes application servers configured to implement and execute CRM software applications as well as provide related data, code, forms, web pages and other information to and from user systems 112 and to store to, and retrieve from, a database system related data, objects, and Webpage content. With a multi-tenant system, data for multiple tenants may be stored in the same physical database object in tenant data storage 122, however, tenant data typically is arranged in the storage medium(s) of tenant data storage 122 so that data of one tenant is kept logically separate from that of other tenants so that one tenant does not have access to another tenant's data, unless such data is expressly shared. In certain implementations, system 116 implements applications other than, or in addition to, a CRM application. For example, system 116 may provide tenant access to multiple hosted (standard and custom) applications, including a CRM application. User (or third party developer) applications, which may or may not include CRM, may be supported by the application platform 118, which manages creation, storage of the applications into one or more database objects and executing of the applications in a virtual machine in the process space of the system 116.

One arrangement for elements of system 116 is shown in FIG. 1, including a network interface 120, application platform 118, tenant data storage 122 for tenant data 23, system data storage 124 for system data 25 accessible to system 116 and possibly multiple tenants, program code 126 for implementing various functions of system 116, and a process space 128 for executing MTS system processes and tenant-specific processes, such as running applications as part of an application hosting service. Additional processes that may execute on system 116 include database indexing processes.

Several elements in the system shown in FIG. 1 include conventional, well-known elements that are explained only briefly here. For example, each user system 112 could include a desktop personal computer, workstation, laptop, PDA, cell phone, or any wireless access protocol (WAP) enabled device or any other computing device capable of interfacing directly or indirectly to the Internet or other network connection. User system 112 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 112 to access, process and view information, pages and applications available to it from system 116 over network 114. Each user system 112 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 116 or other systems or servers. For example, the user interface device can be used to access data and applications hosted by system 116, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 112 and all of its components are operator configurable using applications, such as a browser, including computer code run using a central processing unit such as an Intel Pentium® processor or the like. Similarly, system 116 (and additional instances of an MTS, where more than one is present) and all of its components might be operator configurable using application(s) including computer code to run using processor system 117, which may be implemented to include a central processing unit, which may include an Intel Pentium® processor or the like, and/or multiple processor units.

A computer program product implementation includes a non-transitory machine-readable storage medium (media) having instructions stored thereon/in, which can be used to program a computer to perform any of the processes/methods of the implementations described herein. Computer program code 126 for operating and configuring system 116 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 116 is configured to provide web pages, forms, applications, data and media content to user (client) systems 112 to support the access by user systems 112 as tenants of system 116. As such, system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage system such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

### Architecture

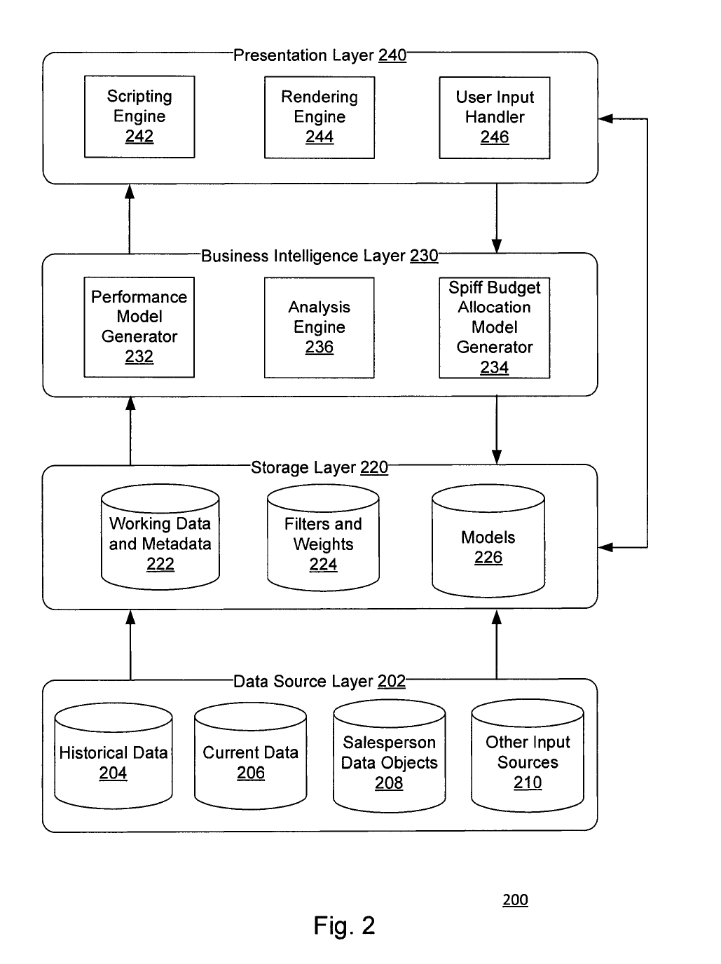

FIG. 2 is a block diagram of an exemplary architecture of a system 200 of an embodiment. The system 200 can be implemented in the environment 110 of FIG. 1, for example, as system 116. The system 200 can include a data source layer 202, a storage layer 220, a business intelligence layer 230, and a presentation layer 240.

The data source layer 202 provides input data (or, “inputs”) for populating the storage layer 220 and can include historical data 204, current data 206, salesperson data objects 208, and other input sources 210. The foregoing examples of input data are not exhaustive or intended to be limiting. Historical data 204 can include: information pertaining to previous sales campaigns such as previously-assigned spiffs, sales quotas, target leads, closed deals, duration, frequency of contacts, lead location(s), salespeople location(s); information pertaining to salespeople's previous performance; and information pertaining to customers' previous activities. The foregoing list of historical data is not exhaustive or intended to be limiting.

Current data 206 can include: information pertaining to current sales campaigns such as active spiffs, sales quotas, target leads, sales stage, duration, last contact, lead location(s), salespeople location(s); information pertaining to salespeople; and information pertaining to customers. The foregoing list of current data is not exhaustive or intended to be limiting.

Salesperson data objects 208 can include data associated with salespersons such as industries, job titles, skill sets, customer satisfaction scores, availability, physical proximity to sales targets, sales stages, target close dates, and active deal sizes. The foregoing list of salesperson data objects is not exhaustive or intended to be limiting. The salesperson data objects 208 can be imported as objects, e.g., using SOAP or any known object access protocol, or can be imported as raw data and then the actual classes and objects can subsequently be created in working data and metadata 222 explained further below.

Other input sources 210 can include any source of data not mentioned above, for example, rules to be imported as filters and weights 224, mined data, or an incoming data stream. Component data sources in the data source layer 202 can come from any external database, for example, an existing CRM or ERP system. The input data from the data source layer 202 can be imported and converted to a format usable by other components in the system 200 using any known method or tool, for example, XSLT, XQuery, Salesforce Data Loader, or any other migration or integration methods or tools. The converted data is stored in the storage layer 220.

The storage layer 220 contains all information that is understood by the higher layers and can include working data and metadata 222, filters and weights 224, and models 226. The working data and metadata 222 can include all data imported from historical data 204, current data 206, and salesperson data objects 208. The filters and weights 224 can include all imported rules, default filters and weights, and user-created filters and weights. The models 226 are all models created by the system 200, for example, the performance models and the spiff budget allocation models. The storage layer 220 is accessed by and returns results to the higher layers.

The business intelligence layer 230 performs intelligent mining and analysis operations and can include a performance model generator 232, a spiff budget allocation model generator 234, and an analysis engine 236. The analysis engine 236 analyzes data stored in the storage layer 220. The analysis engine 236 can process on-demand (i.e., it conducts analysis in response to commands from the model generators or directly from a user), passively (i.e., it conducts analysis as a background service, process, or thread even when it has received no command to do so), or as a hybrid of the two former approaches. An advantage of on-demand processing is that the analysis can be timed to occur after critical data has been imported. An advantage of passive processing is that the processing is staggered over time and results can be made ready any time. A hybridized approach can incorporate advantages of both approaches.

The presentation layer 240 delivers and formats information from lower layers to the users and can include a scripting engine 242, a rendering engine 244, and a user input handler 246. The scripting engine 242 processes client- and server-side scripts that format content for presentation, for example, Flash, PHP, JavaScript, JSP, and/or ASP. The rendering engine 244 pre-renders images and other multimedia content for delivery to the users. The user input handler 246 handles input from the users.

The architecture of system 200 is provided only as an example and is not meant to be limiting. The various components of the architecture are logical components and may be executed by one or more applications running on one or more computers.

### Analysis & Models

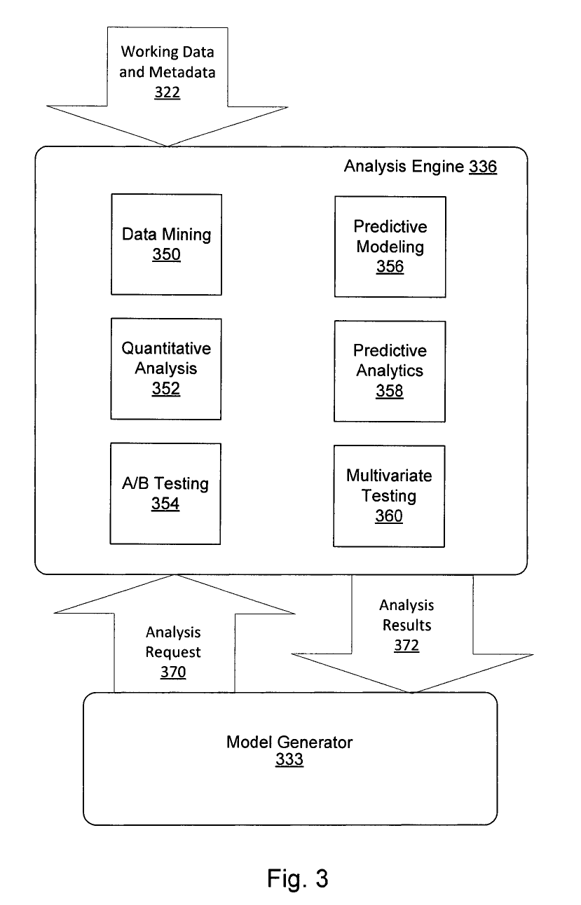

FIG. 3 is a block diagram of an exemplary analysis engine 336 and its interaction with an exemplary model generator 333 according to an embodiment. The analysis engine 336 and model generator 333 can be implemented as components of the system 200 of FIG. 2, for example, as analysis engine 136 and performance model generator 232 (or spiff budget allocation model generator 234) respectively.

The analysis engine 336 analyzes data, for example, working data and metadata 322, stored in the storage layer, which results are used by the model generators 333 to generate models. For example, the performance model generator can instruct or request 370 the analysis engine 336 to generate a performance model corresponding to a particular salesperson. The performance model is then associated with the particular salesperson and a particular sales campaign and may vary its output based on the input parameters. For example, an input parameter can include historical data of the salesperson—a salesperson who historically has sold $x of a particular service or product in previous sales campaigns can be expected to continue to do so in the current sales campaign, all else equal. The created or generated performance model can output a number, for example, an anticipated sales result of the particular salesperson in the subject sales campaign. The output of the performance model or the performance model itself can be returned in the analysis results 372.

To account for the many factors that may affect a given output, the analysis engine 336 has many packages such as data mining 350, quantitative analysis 352, A/B testing 354, predictive modeling 356, predictive analytics 358, and multivariate testing 360. Each of the packages may access their own set of exclusive tools (e.g., full factorial, choice modeling, or Taguchi methods, which are exclusive to a/b testing and multivariate testing) and/or may have shared tools (e.g., average( ), sum( ), min( ), max( ), etc.) The analysis request 370 may also contain instructions on which package(s) to use; these instructions can be customized by the users and/or the model generator may have default and template instructions that are selected by the model generator intelligently in light of different scenarios. For example, the model generator 333 may issue an analysis request 370 to use the data mining package 350 and not the predictive modeling package 356 to search for patterns in large datasets with no known conditions. As another example, when certain strong correlations are known or suspected, the model generator 333 may issue an analysis request 370 to use the quantitative analysis package 352 to access a neural networks tool within the package.

The analysis request 370 may also contain filters and weights to be used as additional parameters for the analysis engine 336. For example, the user may decide that only salespeople with skill sets “Business Service Management Software”, “Cloud Computing”, and “Strategic Lead Creator” should be used for a sales campaign for a new BSM SaaS that is soon to become generally available. An appropriate filter can be created from a user interface by the user, and the filter instructions can be handled by the user input handler and forwarded to the performance model generator such that salespeople who do not meet the criteria are not selected, thus allowing the analysis engine to formulate a more efficient query plan and saving valuable computing cycles and memory space on the storage layer, the analysis engine 336, and the performance model generator. As another example, the user may recognize that a particular customer tends to prefer face-to-face interactions. The salesperson data objects' location field may then be used to calculate a proximity to the particular customer, and the proximity may be given a heavier weight in selecting the salespeople that are likely to have higher sales results with the particular customer.

In another embodiment, the filters and weights are not a part of the analysis request 370, but instead were previously saved to the storage layer and can be retrieved by the analysis engine 336 for consideration during analysis. The filters and weights can be returned to the analysis engine 336 in its data request to the storage layer upon the triggering of a specific condition. For example, whenever a customer who prefers face-to-face interactions has significant potential in a sales campaign, the weight will automatically be returned to the analysis engine 336 during analysis. The automatically-returned filters and weights can then be incorporated into the analysis results 372 and also associated with the generated models in a persistent manner so that downstream or later retrieval of the models allows the user to better understand and adjust the models. This can be useful for training the analysis engine 336 or model generators 333, for example, by allowing the user to adjust weights or choose packages and tools.

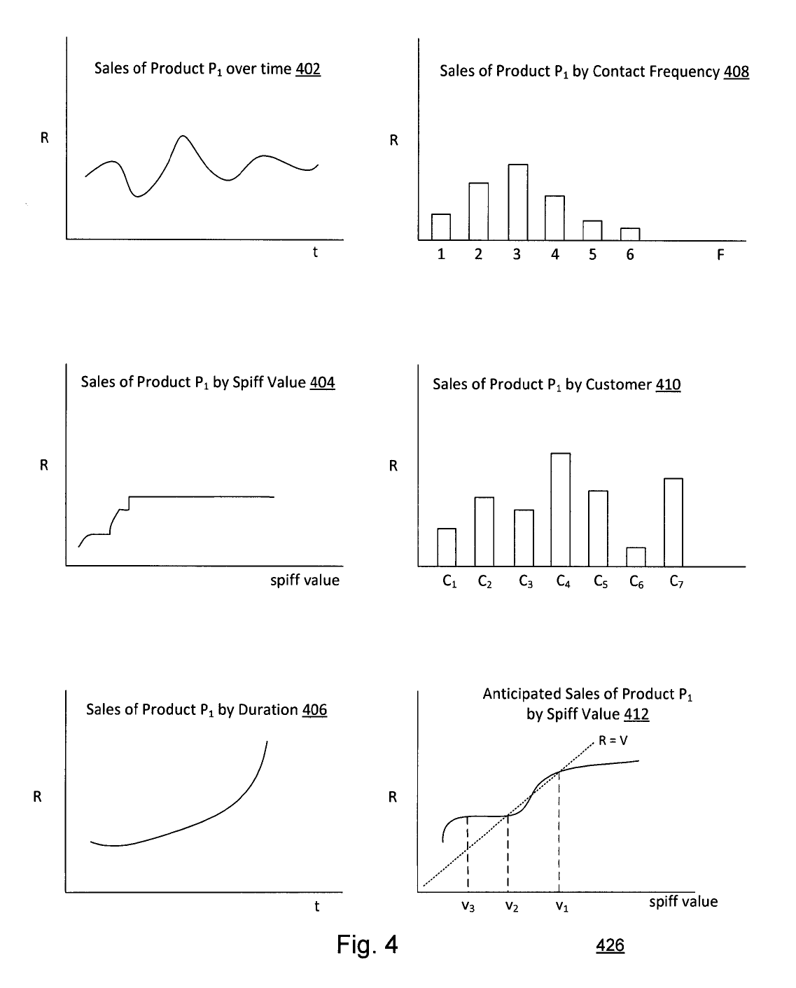

FIG. 4 is a graphical representation of an exemplary performance model 426 of an embodiment. The performance model 426 can be implemented, for example, as a model 226 generated by the performance model generator 232 of FIG. 2. The performance model 426 is associated with a salesperson and product or service and can optionally be associated with a particular sales campaign. The performance model 426 can include multiple sub-models, for example, the regression-based sub-models 402-410, as well as one or more predictive models, for example, the anticipated sales of product P₁ by spiff value model 412. The sub-models of the performance model 426 can be associated with the salesperson and/or product or service. The sub-models can be generated in isolation to other variables when using, for example, a regression analysis package. The sub-models are then aggregated by the performance model generator to create a predictive model 412 based on the input parameters.

The sub-models can be stored in the storage layer for other performance models to later reference in accordance with a create-once-query-many-times scheme to save space and processing cycles. Thus, the performance model 426 can be a collection of pointers to sub-models that are stored in the storage layer. When new data enters the storage layer, the model generators can actively (i.e., upon user request to refresh) or passively (i.e., as a background service, process, or thread) refresh the sub-models so that the sub-models have up-to-date information when their data is referenced.

The sub-models can be aggregated using any of the analysis packages and tools or based on trained data. For example, using the regression analysis package, the sub-model 412 can be generated with the performance model's recognition that model 402 shows that the salesperson's sales of product P₁ are converging to a number or range over time, model 404 shows increasing sales revenues until a plateau point, model 406 shows that the salesperson tends to generate higher revenues when given more time, model 408 shows that the salesperson tends to generate higher revenues when contacting a potential lead between 2 and 4 times, and model 410 shows that the salespersons tends to generate higher revenues with customers C₄ and C₇ both of which are leads in the current sales campaign. Thus, one potential aggregation would be to use model 404 with matching axes as a baseline model and then adjust the baseline model accordingly in light of the other models, for example, upwardly due to the relatively long duration parameter associated with the current sales campaign in light of model 406, and upwardly due to the fact that customers C₄ and C₇ are both target leads in the current sales campaign in light of model 410.

Various sub-models can serve as factors for calculating a confidence measure of predictive model 412. For example, model 402 may increase the performance model generator's confidence measure of predictive model 412 due to the converging nature of the data in model 402. As another example, model 410 may decrease the performance model generator's confidence measure of model 412 if another sub-model (not shown) indicates that customers C₄ and C₇ both purchased product P₁ within the past quarter and have a product purchase frequency for P₁ that is much lower than 1/Q.

The data in the sub-models of the performance model 426 is shown as curved lines, but the original data can be a collection of data points. The curved lines can represent an interpolation or extrapolation of a plurality of data points, created using any known numerical approximation method. For higher accuracy and higher computational complexity, higher-order polynomials can be used to curve-fit the data. For lower accuracy and faster computation, lower-order polynomials can be used to curve-fit the data. Irrespective of whether the data is curve-fit, it is preferable to preserve the original data points in the sub-model data to minimize error in downstream calculations.

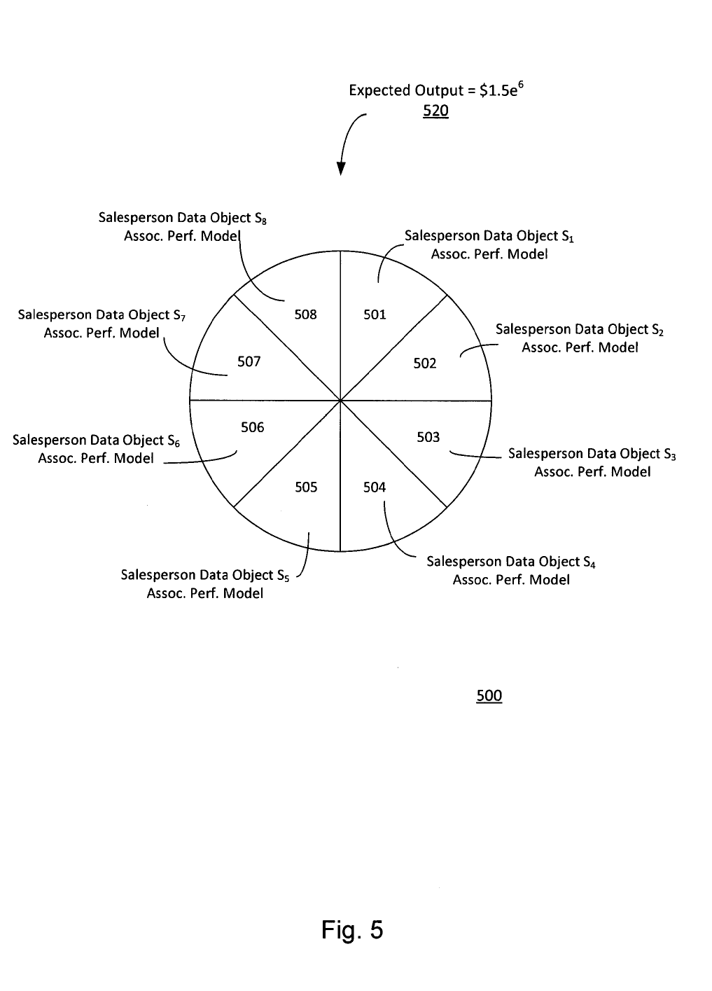

FIG. 5 is a graphical representation of an exemplary spiff budget allocation model 500 according to an embodiment. The spiff budget allocation model 500 can be implemented, for example, as a model 226 generated by the spiff budget allocation model generator 234 of FIG. 2. The model generator takes as input a current sales campaign, a spiff budget, and salesperson data objects to generate the spiff budget allocation model 500. The model generator divides the spiff budget 520 into subdivisions 501-508 and assigns each of the subdivisions to a salesperson data object S₁-S₈based on the performance models so as to maximize the sum total performance. The model generator can achieve this by using one or more well-known algorithms that are commonly used to solve other engineering problems.

Algorithm 1: Greedy. Using a Greedy algorithm, the model generator orders payoff quotients, PQ. A payoff quotient is defined as a revenue over a spiff value, R/V. Thus, for example, the portion of the graph at v₁ in predictive model 412 of performance model 426 can be considered to have the same payoff quotient as the portion of the graph at v₂, since both portions fall on the R=V line. With the ordered payoff quotients, the model generator then selects payoffs in order. For example, if a salesperson data object has a maximum payoff quotient at v₃ equal to, say, PQ₁, and this is the highest PQ among the predictive models corresponding to the salesperson data objects in question, then the model generator first assigns spiff v₃ to the corresponding salesperson data object. The model generator then continues in this manner until all salesperson data objects participating in the sales campaign have been accounted for.

The foregoing algorithm can be further optimized by either (a) eliminating portions with non-negative second derivatives, or (b) finding all of the global and/or local maxima for the predictive models for the participating salesperson data objects and using the maxima as PQ points. Although method (b) may be faster, it may lose additional information by failing to account for error.

Algorithm 2: Simulated Annealing. Using a Simulated Annealing approach, the model generator starts with a baseline, e.g., equitable distribution where the spiff budget 520 is divided equally between all of the participating salesperson data objects in the sales campaign. Using this baseline, the model generator randomly or pseudo-randomly makes internal contributions, for example, by taking $x away from S₁'s subdivision and giving the $x to S₅. For each internal contribution, the model generator tests whether the sum total of the anticipated payoffs increases. If the sum total increases (or optionally stays the same), the model generator keeps the internal contribution. If the sum total decreases (or optionally stays the same), the model generator discards the internal contribution. The model generator can be set to make up to n internal contributions before stopping, where n can be customized by the user depending on time and space requirements, or n can be set to a default.

Algorithm 3: Dynamic Programming. Using a Dynamic Programming approach, the model generator generates an ordered set of payoff quotients as described above. However, rather than selecting the highest payoff first, the model generator recursively takes the maximum revenue that can be attained with spiff value, v, such that M[v]=maxᵥ_{_{—}}_{i≦v}(Rᵢ+M[v−vᵢ]), where M[v] is a maximum value function that can be attained with spiff value v, vᵢ is the spiff value of the ith salesperson data object, and Rᵢ is a revenue generated by the ith salesperson data object. This approach assumes that M[0]=0 (summation of the null set). This approach models the unbounded knapsack problem, and runs in pseudo-polynomial time. Of course, the approach can be further optimized depending on the data set and other assumptions, for example, by first sorting the ordered payoff quotients (e.g., using a quicksort algorithm) and then assuming that not all salesperson data objects must be included (i.e., satisfying dominance relationships after reducing the unbounded knapsack problem to the bounded version).

The foregoing algorithms are not an exhaustive set of example algorithms that could be used to solve the foregoing sum total performance maximization problem. However, the foregoing algorithms guarantee that the model generator will generate an allocation model that is at least as good as an equitable distribution (assuming the equitable distribution is optimal) and no worse.

Further, disclosed embodiments are advantageous in that they are data driven and present objective results. Thus, a sales manager who suspects that larger spiffs should be awarded to lower performers rather than higher performers due to a lower performer's higher elasticity of generated revenue as a function of spiff value can use the system to verify the suspicion position. Furthermore, the below-described interface allows the sales manager to adjust the weights, statistical models, and algorithms accordingly if they do not attribute proper weight to the above-described phenomenon.

### User Interface

In addition to presenting information, the user interface presented by the presentation layer serves to allow the user to (1) modify various parameters associated with a sales campaign in order to possibly achieve a more optimal allocation, and (2) learn the significance of various factors in the model calculation.

In one embodiment, the performance model 426 is shown graphically in the user interface, for example, as shown in FIG. 4. The user interface can allow the user to select or deselect sub-models that are aggregated to achieve the predictive model 412. As the user submits the user's selection or de-selection of sub-models, the predictive model 412 can be recalculated on the fly, so that the user can better understand what factors contributed to the predictive model 412.

In another embodiment, the spiff budget allocation model 500 is shown graphically in the user interface, for example, as shown in FIG. 5. The user interface can allow the user to manually make internal contributions, for example, by dragging the borders between subdivisions. As the user submits the user's modifications, the spiff budget allocation model 500 can be calculated on the fly to display a new expected output amount, so that the user can attempt to make further optimizations.

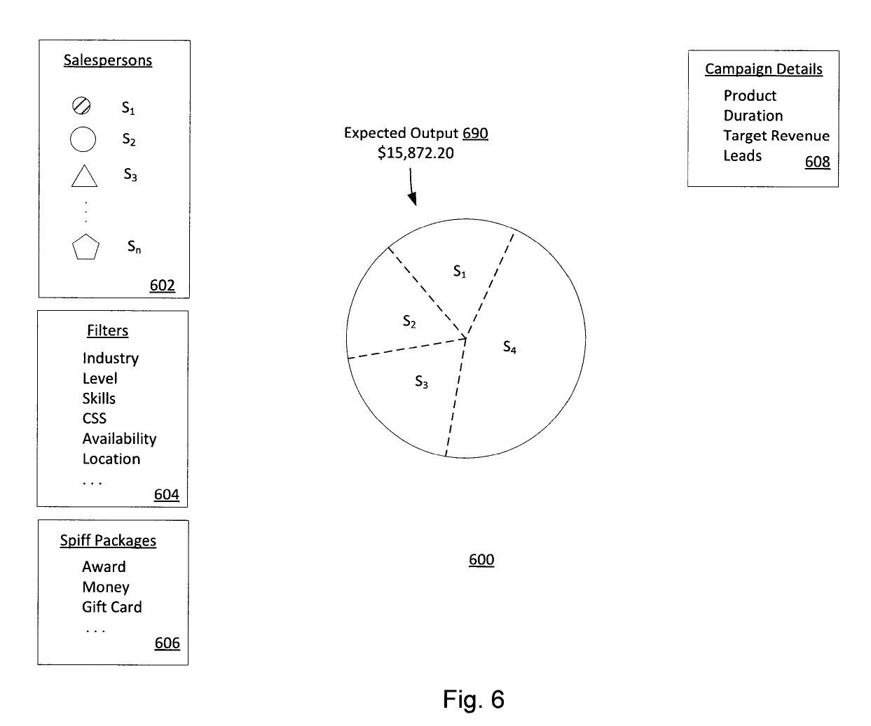

FIG. 6 is a screenshot of an exemplary user interface 600 according to an embodiment. The user interface 600 can be displayed by the presentation layer 240 of FIG. 2. The user interface 600 can include informational frames 602-606 and a graphical representation of a spiff budget allocation model including an expected output 690.

Informational frame 602 shows the salespeople participating in the sales campaign. They can be selected or de-selected through the informational frame 602. As the user submits the user's selection or de-selection of salespeople, the spiff budget allocation model can be regenerated on the fly. Disclosed embodiments allow for on-the-fly or near-real-time model regeneration due to the fact that the processor-intensive activity (e.g., generating the performance models) has already been completed by the performance model generator.

The informational frame 602 can provide additional information about each salesperson, for example, through an activation means such as mousing over the corresponding graphical object or right-clicking the object to open a menu and selecting a menu item.

Informational frame 604 shows various filters that may be applied. For example, the user can select or de-select items to exclude or include salespeople that match the filter set.

Informational frame 606 shows various spiff packages that may be applied. The performance models may include sub-models that track how a salesperson responds differently with different compensation formats. For example, salesperson S₁ might historically have produced higher sales revenues when incentivized with a $15,000 luxury watch with $200 engraving rather than with $15,200 in cash. Informational frame 606 allows the user to edit spiff packages and apply the packages to individual salespersons, the expected output 690 changing on the fly. Further, the spiff budget allocation model generator might have already determined optimal spiff packages based on the aforementioned performance models. If so, the user interface can also display the determined optimal spiff packages, for example, when the user mouses over the salespeople S₁ to S₄ either in informational frame 602 or in the graphical representation of the spiff budget allocation model.

Informational frame 608 shows campaign details for the current sales campaign. The campaign details can also be edited by the user and saved as a new campaign in the system, for example, in another database in the storage layer.

### Method

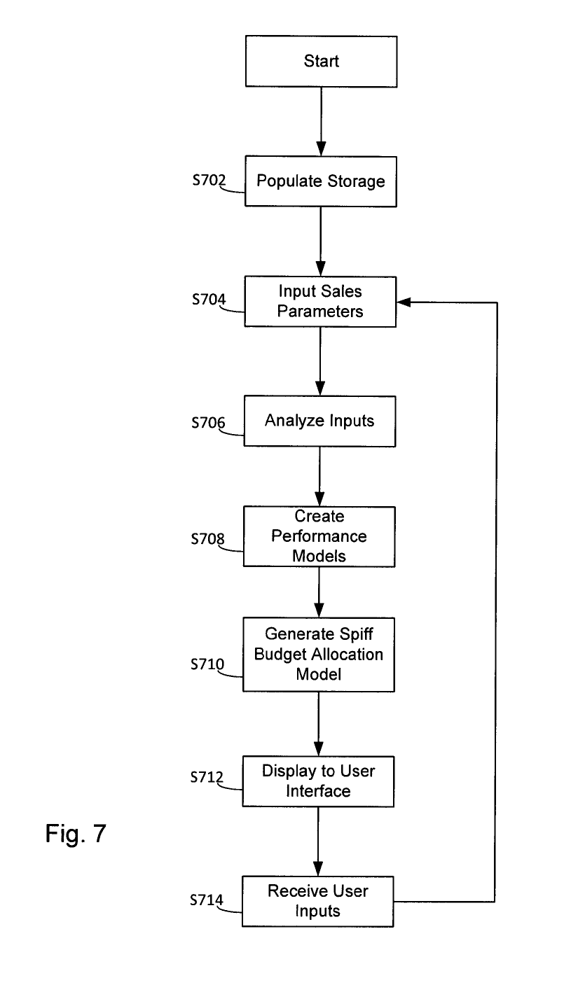

FIG. 7 is a flow diagram of an exemplary method 700 according to an embodiment. The method 700 starts by populating the storage at S702. Then, the user inputs sales parameters at S704. Then, the system analyzes the inputs at S706. Then, the system creates performance models at S708. Then, the system generates a spiff budget allocation model at S710. Then, the system displays the models in the user interface at S712. Optionally, the system may receive user inputs at S714, which for example, may edit the sales parameters at S704.

Various modifications may be made to the method 700. For example, it is not required that S704 and S706 occur before S708. As described above, the performance models may be generated prior to creation of a new sales campaign. Further, it is optional that the system displays the results in a user interface at S712. The model data may instead be exported to another system for display or further analysis.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A system for improving a spiff allocation, the system comprising:
a processor; and
a memory storing one or more stored sequences of instructions which, when executed by the processor, cause the processor to carry out the steps of:
analyzing a plurality of inputs including a plurality of data objects each being associated with one or more salespeople and a plurality of previously assigned spiffs and corresponding sales results associated with the data objects;
creating a plurality of performance models based on the analyzing, each performance model projecting an anticipated sales result of the one or more salespeople;
generating a spiff budget allocation model based on the performance models, the spiff budget allocation model dividing a spiff budget into a plurality of subdivisions, each subdivision being associated with at least one of the data objects so as to increase a sum output of the anticipated sales results as compared to an equitable distribution of the spiff budget between the data objects.

2. The system of claim 1, the memory further storing instructions that cause the processor to carry out the step of: excluding at least one of the data objects from being associated with a subdivision, with a filter function.

3. The system of claim 2, wherein the filter function is based on at least one of the group consisting of an industry, a job title, a skill set, a customer satisfaction score, an availability, a physical proximity to a sales target, a sales stage, a close date, and a deal size associated with the at least one of the data objects.

4. The system of claim 1, wherein
the spiff budget includes a plurality of assets, and
the analyzing includes assigning an effectiveness weight between each of the data objects and each of the plurality of assets.

5. The system of claim 1, wherein the performance models are based on at least one of the group consisting of an industry, a job title, a skill set, a customer satisfaction score, an availability, a physical proximity to a sales target, a sales stage, a close date, and a deal size associated with the at least one of the data objects.

6. The system of claim 1, the memory further storing instructions that cause the processor to carry out the step of: displaying a plurality of factors contributing to the performance models and an impact of each of the factors on the performance models.

7. A computer program product, including a non-transitory machine-readable medium storing one or more sequences of instructions, which when executed by one or more processors, cause a computer to perform a method for improving a spiff allocation, the method comprising:
analyzing a plurality of inputs including a plurality of data objects each being associated with one or more salespeople and a plurality of previously assigned spiffs and corresponding sales results associated with the data objects;
creating a plurality of performance models based on the analyzing, each performance model projecting an anticipated sales result of the one or more salespeople;
generating a spiff budget allocation model based on the performance models, the spiff budget allocation model dividing a spiff budget into a plurality of subdivisions, each subdivision being associated with at least one of the data objects so as to increase a sum output of the anticipated sales results as compared to an equitable distribution of the spiff budget between the data objects.

8. The computer program product of claim 7, the method further comprising: excluding at least one of the data objects from being associated with a subdivision, with a filter function.

9. The computer program product of claim 8, wherein the filter function is based on at least one of the group consisting of an industry, a job title, a skill set, a customer satisfaction score, an availability, a physical proximity to a sales target, a sales stage, a close date, and a deal size associated with the at least one of the data objects.

10. The computer program product of claim 7, wherein
the spiff budget includes a plurality of assets, and
the analyzing includes assigning an effectiveness weight between each of the data objects and each of the plurality of assets.

11. The computer program product of claim 7, wherein the performance models are based on at least one of the group consisting of an industry, a job title, a skill set, a customer satisfaction score, an availability, a physical proximity to a sales target, a sales stage, a close date, and a deal size associated with the at least one of the data objects.

12. The computer program product of claim 7, the method further comprising: displaying a plurality of factors contributing to the performance models and an impact of each of the factors on the performance models.

13. A method for improving a spiff allocation, the method comprising:
analyzing a plurality of inputs including a plurality of data objects each being associated with one or more salespeople and a plurality of previously assigned spiffs and corresponding sales results associated with the data objects;
creating a plurality of performance models based on the analyzing, each performance model projecting an anticipated sales result of the one or more salespeople;
generating a spiff budget allocation model based on the performance models, the spiff budget allocation model dividing a spiff budget into a plurality of subdivisions, each subdivision being associated with at least one of the data objects so as to increase a sum output of the anticipated sales results as compared to an equitable distribution of the spiff budget between the data objects.

14. The method of claim 13, the method further comprising: excluding at least one of the data objects from being associated with a subdivision, with a filter function.

15. The method of claim 14, wherein the filter function is based on at least one of the group consisting of an industry, a job title, a skill set, a customer satisfaction score, an availability, a physical proximity to a sales target, a sales stage, a close date, and a deal size associated with the at least one of the data objects.

16. The method of claim 13, wherein
the spiff budget includes a plurality of assets, and
the analyzing includes assigning an effectiveness weight between each of the data objects and each of the plurality of assets.

17. The method of claim 13, wherein the performance models are based on at least one of the group consisting of an industry, a job title, a skill set, a customer satisfaction score, an availability, a physical proximity to a sales target, a sales stage, a close date, and a deal size associated with the at least one of the data objects.

18. The method of claim 13, further comprising: displaying a plurality of factors contributing to the performance models and an impact of each of the factors on the performance models.
